(19) United States
(12) Patent Application Publication
(10) Pub. No.: US 2003/0023746 A1
(43) Pub. Date: Jan. 30, 2003

(54) Method for reliable and efficient support of congestion control in nack-based protocols

(75) Inventor: Dmitri Loguinov, Wappingers Falls, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/915,678

(22) Filed: Jul. 26, 2001

(51) Int. Cl. G06F 15/16

(52) U.S. Cl. 709/235

(57) ABSTRACT

Disclosed is a system and method for exchanging a plurality of messages between a server and a client over a communication link to support congestion control therebetween. The present invention provides congestion control in real-time streaming applications over the Internet between the server and the client, by employing an inventive data structure in NACK-based applications to support multiple retransmission attempts per lost packet. The ability to control network traffic without employing a retransmission timeout (RTO) protocol in NACK-based applications allows for the efficient handling of a large variety of network traffic, including video and multimedia traffic.

### BACKGROUND OF THE INVENTION

1. Field of the Invention

The present invention relates to digital packet transmissions, and particularly, to a method and system for exchanging control packets to support the congestion control in a digitally switched packet telecommunication environment.

2. Description of the Invention

Many Internet streaming applications require congestion control, which permits the client nodes and server nodes to initially set the transmission rate value to a specific value and thereafter adjust the rate to accommodate the dynamics of message transmission over the data link. Currently, there are two types of Internet transport protocols that support congestion control and lost packet recovery in a data communication network. The first approach is ACK-based as set forth under the transmission control protocol (TCP), which involves the receiver (or client) sending a positive acknowledgment (ACK) in response to each received packet. Each ACK packet provides a sample of the RTT and carries information about lost packets. FIG. 1(a) illustrates the positive acknowledgments (ACK) process of the TCP for data arriving to the receiving endpoint as the mechanism for error recovery. This system operates under the principle that only unacknowledged frames should be retransmitted. To ensure that the packet is safely received by the sending source, TCP uses a retransmission timeout (RTO) mechanism by managing a retransmission timer for each connection. That is, TCP sets the retransmission timer and tacks an RTO value and a round trip time (RTT) for the connection. The RTT is the time elapsed between the start of transmission of a TCP-type data segment and the receipt of an acknowledgment of that segment. If an acknowledgment is not received by the time the RTO₁ expires, TCP retransmits the data again within the next RTO₂.

The second approach is NACK-based under a user datagram protocol (UDP), which involves the receiver sending a negative acknowledgment (NACK) in response to each lost packet. FIG. 1(b) illustrates the UDP system of negative acknowledgments (NACK) which involves the forwarding of a NACK packet to the sending source (or server) in response to the lost frame for retransmission. As shown in FIG. 1(b), the NACK packet can be lost along the path from the receiver to the sender. The UDP utilizes a retransmission timeout (RTO) mechanism that is similar to the TCP for retransmission connection. The RTO estimation is performed by predicting the next value of the RTT based on the previous samples of the RTTs. If the RTO is overestimated, it leads to a lower throughput performance in TCP and may cause an increased number of under-flow events in real time application. Yet, if the RTO is underestimated, the protocol generates a large number of duplicate packets that cause serious network congestion as more of unnecessary packets are retransmitted. In practice, due to historical reasons, many of the proposed congestion control schemes rely on window-based flow control, similar to the flow control found in TCP.

In real-time streaming applications, e.g., multimedia applications, a NACK-based operation is preferred due to a lower overhead along the path from the receiver to the sender and a potentially faster recovery of lost packets. However, congestion control in NACK-bases protocols is typically considered difficult due to a higher degree of oscillation (which is caused by the “open-loop” operation of NACK-based congestion control), and inability of NACK-based schemes to derive RTT samples from each sent packet (which results in a low frequency of feedback). Furthermore, no common methods exist for NACK-based protocols to efficiently (i.e., with few timeouts) overcome the loss of control messages. Therefore, the present invention relates to an improved mechanism of exchanging congestion control messages in the NACK-based environment between the server and the client, while achieving a low level of oscillation, high frequency of measuring the RTT, high resilience against packet loss, high bitrate scalability, efficient NACK-based retransmission, and full functionality of traditional ACK-based congestion control.

### SUMMARY OF THE INVENTION

The present invention is directed to a method and system for providing congestion control in a real-time streaming application over the Internet between a server and a client.

One aspect of the present invention relates to a method of adjusting a sender rate in a packet communication system to support congestion control between a server and a client. The method includes the steps of: transmitting a plurality of data packets to the client; determining whether one of the data packets is lost over a communication connection from the server to the client; transmitting a response packet for retransmission by the client if one of the data packets is lost; computing a new sender rate based on the packet loss ratio and a round-trip time (RTT) corresponding to a latency between sending the response packet to the server and receiving the corresponding retransmission of the lost packet from the server; and, adjusting the new sender rate by the server if a predetermined number of RTTs is detected during said communication connection.

Another aspect of the invention relates to a system of adjusting a sender rate in a packet communication system to support congestion control between a server and a client. The system includes a means for receiving a plurality of data packets; a means for determining whether one of the data packets is lost during transmission; a means for requesting that any lost frame packets be retransmitted; a means for computing a new sender rate based on the packet loss ratio and a round-trip time (RTT) corresponding to a latency between requesting retransmission of the lost frame to the server and receiving corresponding retransmission of the lost frame from the server; and, a means for notifying the new sender rate to the server if the number of calculated RTTs thereafter satisfies a predetermined threshold value.

These and other advantages will become apparent to those skilled in this art upon reading the following detailed description in conjunction with the accompanying drawings.

### BRIEF DESCRIPTION OF THE DRAWINGS

FIG. 1(a) illustrates representative data flows in the TCP communication environment;

FIG. 1(b) illustrates representative data flows in the UDP communication environment;

FIG. 2 illustrates a block diagram of a system according to the present invention;

FIG. 3 illustrates the format of a user datagram protocol (UDP) packet at the server end in accordance with the present invention;

FIG. 4(a) is a time chart depicting the exchange of packets to measure a round-trip time (RTT) in accordance with the present invention;

FIG. 4(b) is a comparison time chart depicting the exchange of packets to overcome the loss of a control action packet in accordance with the present invention; and,

FIG. 5 is a flow chart illustrating the operation of the congestion control in accordance with the present invention.

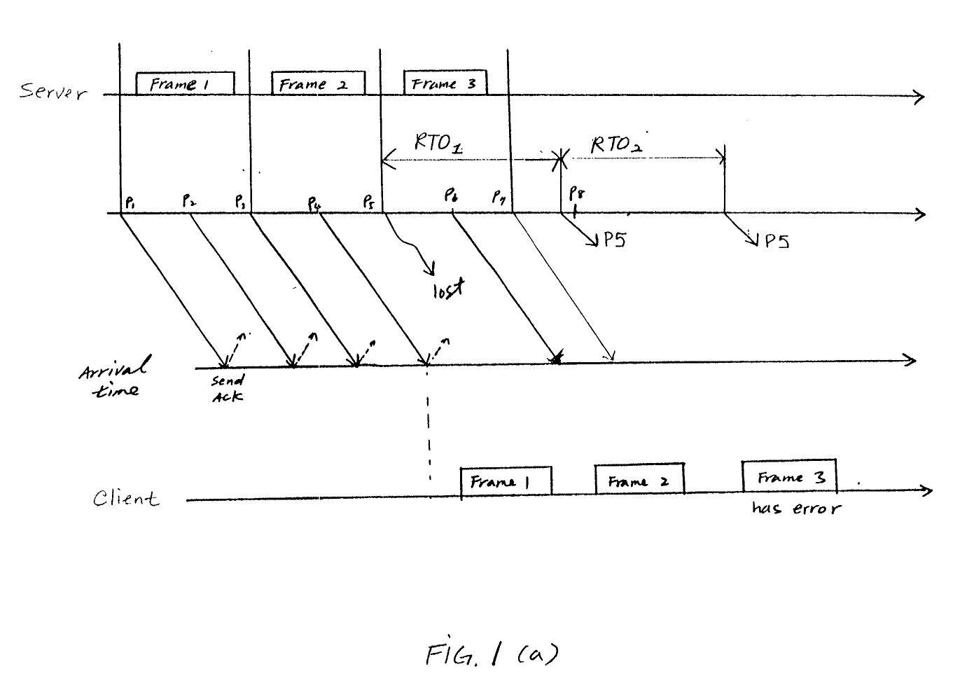

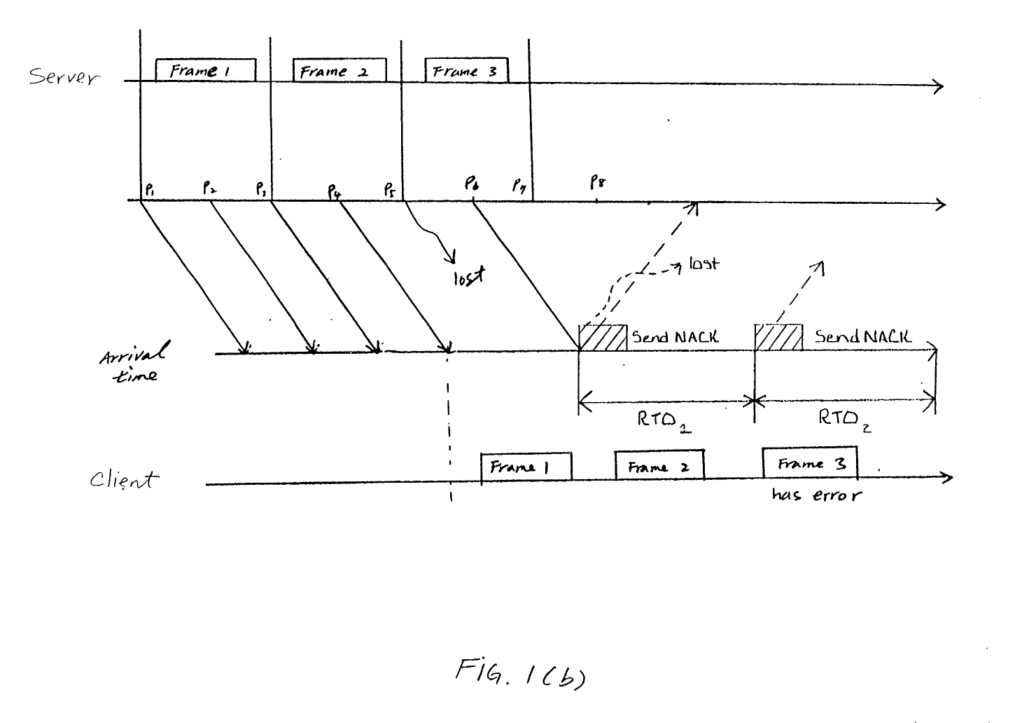

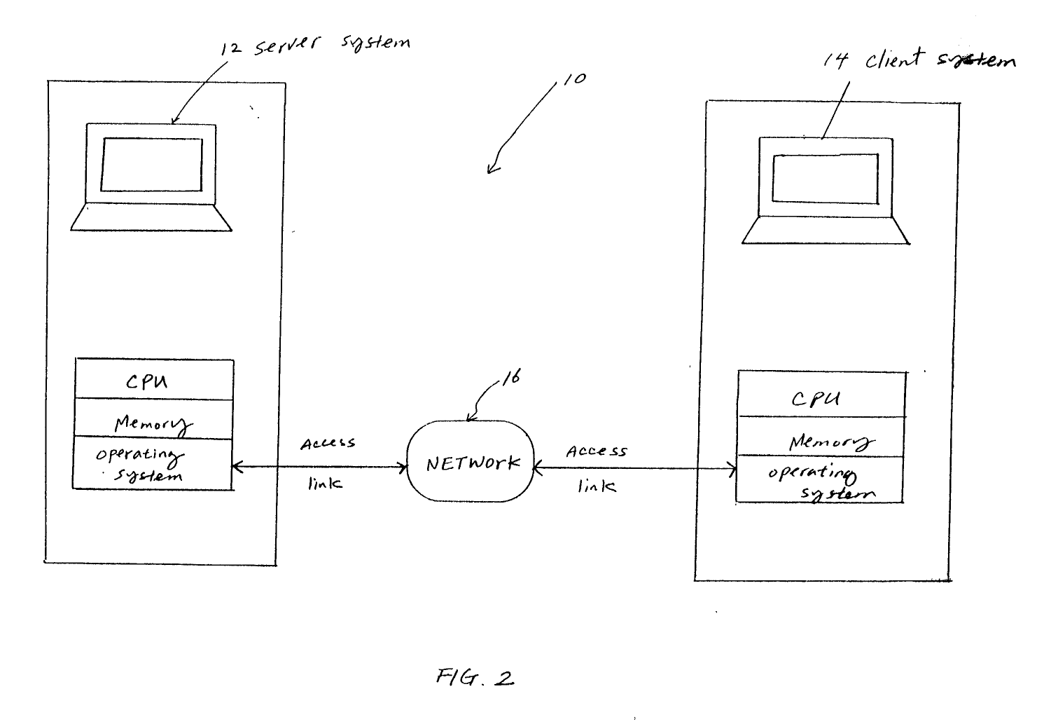

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. In addition, for the purpose of clarity and simplicity, detailed descriptions of well-known devices, circuits, and methods are omitted so as not to obscure the description of the present invention with unnecessary detail.

The operation of a congestion control according to the present invention is performed when a client determines that the packets from the server are arriving at too fast a rate, such that it may become congested. To this end, the client inserts congestion control information into the response message that it transmits, which reduces the rate at which the server that receives the response message may transmit packets to the client. If the congestion thereafter abates, the client node transmits congestion control information in the response packet that permits the recipient server to increase the rate at which it may transmit packets to the client. In addition, the present invention provides a mechanism to enable the client to detect the loss of retransmission without using the retransmission timeouts (RTOs) as in the prior art system, thus providing quicker recovery of lost packets. Moreover, the inventive mechanism is resilient against packet loss and reordering along the path from the client to the server. That is, the operation of the inventive mechanism prevents the server from reacting to the out-of-date and reordered congestion control messages sent by the client. Furthermore, the inventive mechanism allows the dampening of congestion control operation to be adjusted to a specific congestion control algorithm and provides different degrees of dampening for the increase and decrease cycles of congestion control (explained later).

Referring to FIG. 2, a system 10 which uses the present invention comprises a server 12 and a client system 14, which is in communication with each other via access link of the network 16. The communication connection between the server and the client may include at least one of a wireless communications link, a wired communication link, and the combination of a wired communication link and a wireless communications link. Both the server 12 and the client 14 may include, for example, a personal computer or computer workstations, which may be used by one or a few users. The chosen embodiment of the present invention is a software executing within the server and client systems. Computer programs (or computer control logic) are stored in the main memory of the respective system. Such computer programs, when executed, enable the respective system to perform the function of the present invention as discussed herein. It should be noted that the network shown in FIG. 2 is small for the purpose of illustration, but in practice the network may include a much larger number of different computer systems. In addition, it should be noted that the present invention can be practiced in a client-server environment, but the client-server environment is not essential.

According to the embodiment of the present invention, there are two types of control packets that the client 12 transmits to the server 14 during the congestion control operation. The first type of message carries retransmission requests, which are typically called NACK messages. The second type of message is called congestion control (CC) messages, which carries the new transmission rate to be implemented over the path from the server 12 to the client 14. That is, the output of the congestion control operation indicating the new transmission rate, r(t), is transmitted from the client 14 to the server 12. Here, the new transmission rate, r(t), is calculated based on the packet loss ratio of server packets and round trip time (RTT) of control packets. Computing the new transmission rate or new sender rate based on the measured RTT and/or packet loss rate is well known in the art and can be performed in a variety of ways. The exact computation of the new transmission rate is implementation-dependent, and those skilled in this art know that there are many different ways. For example, a technique for determining a sender rate based on the transmission delay and RTT is disclosed in the U.S. Pat. No. 6,115,357 filed June, 29, 1998, which is incorporated herein by reference. In the embodiment, the new transmission rate, r(t), is inserted into each NACK message. Alternatively, if there are no lost packets, the new transmission rate, r(t), is sent to the server 12 via the congestion control (CC) packet from the client 14 to the server 12.

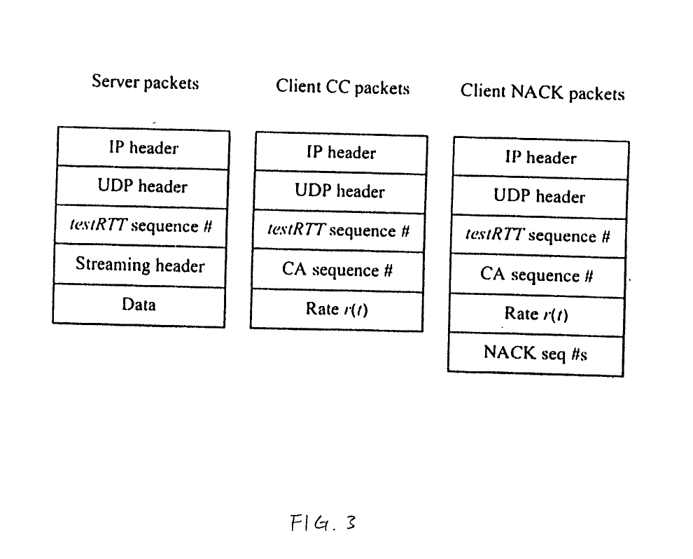

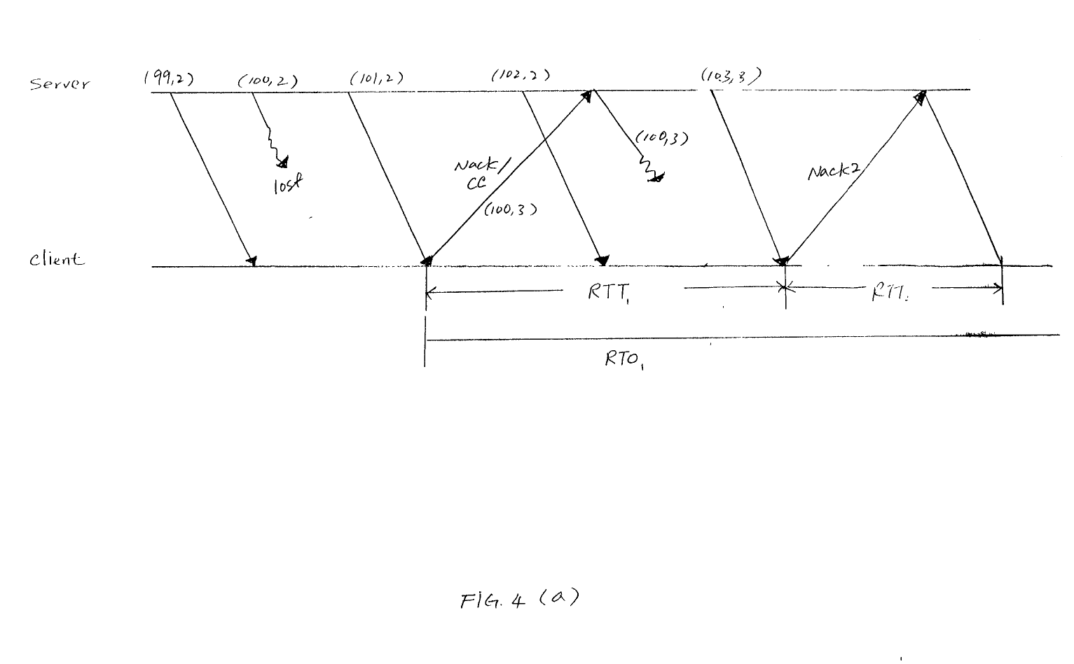

The pacing of data flows is based in part, on a transmission delay and round trip time (RTT). FIG. 3 illustrates the structure of packet headers, as described in the preceding paragraph, that are used to exchange control packets between the client 14 and the server 12 to perform the congestion control according to the embodiment of the present invention. It should be apparent to those skilled in the art that other data structures from the one shown can be successfully used, including but not limited to fields of different size, arranging the fields in different order, and additional fields not present in FIG. 3.

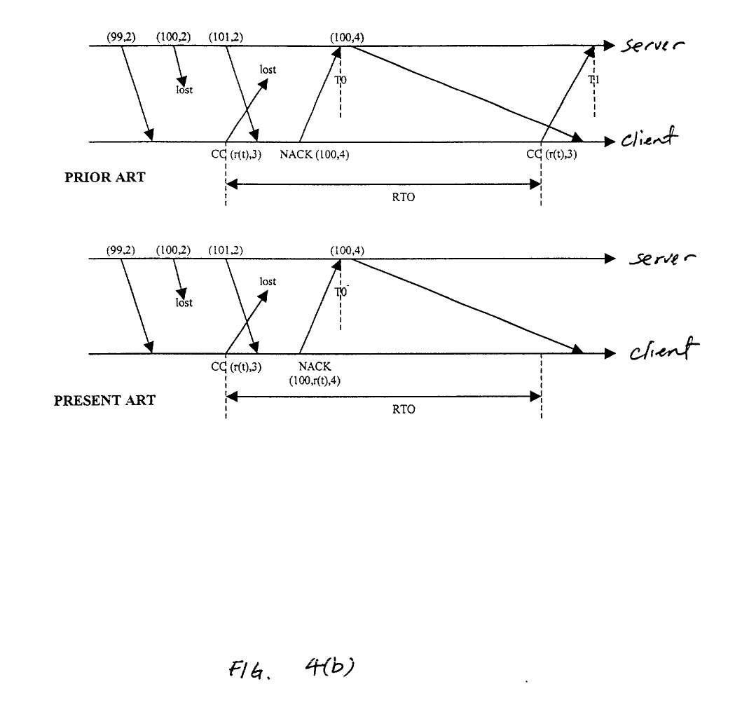

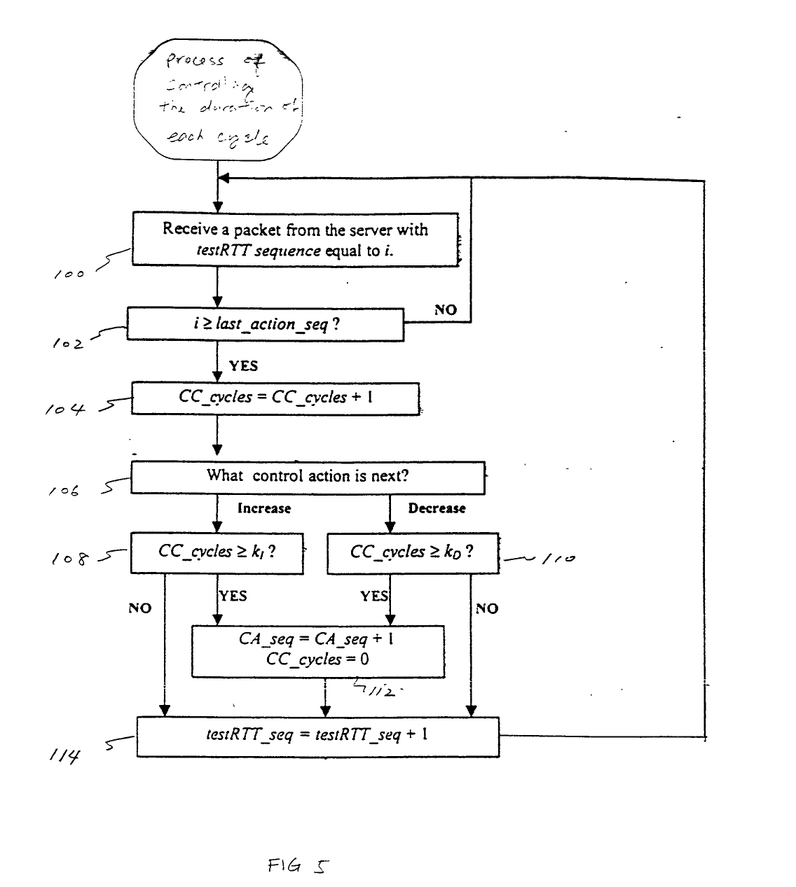

As shown in FIG. 3, every packet sent by the client 14 contains two fields that are not present in the prior art method. The first field, testRTT sequence, is used to measure the RTT and detect whether the retransmission packets have been lost. To this end, the server 12, upon receiving a control packet from the client 14, copies the most recently received testRTT sequence from the client 14 into each packet it forwards to the client 14. Then, by timing the duration between sending a request with a specific testRTT sequence and receiving a server packet with the same sequence number, the client 14 computes the RTT. For example, notation (x,y) in the FIGS. 4(a) and 4(b) represents a packet whose sequence number is x and whose testRTT_sequence is y. As shown in FIG. 4, if a packet (100, 2) is lost during the transmission, a NACK packet (100, 3) is transmitted to the server 12 for retransmission. Thereafter, the requested packet (100, 3) is retransmitted from the server 12 to the client 14 and also lost. Nevertheless the client receives the next source packet (103,3), which indicates that the server has received client's request. Assuming a FIFO network, the client can infer the loss of the retransmitted packet (100,3). Hence, by observing the testRTT sequence changing from packet (102,2) to packet (103,3), the client 14 can generate a round trip time (RTT) in accordance with the present invention and send a second NACK for packet 100 when it receives packet (103,3). That is, if the client 14 sends a NACK with testRTT sequence i and consequently receives a server packet with a testRTT sequence greater than or equal to i, and if by this time the client 14 has not received the retransmission requested in NACK with sequence i, then the client 14 knows that the requested retransmission packet has been lost and that the NACK packet should be sent again. The round trip time (RTT) is defined as the time between sending a request (either a NACK or a CC) to server 12 and the receipt of a server packet indicating that the server has received the client's request (i.e., a packet with a testRTT_sequence greater than or equal to the last one sent by the client). Thus, both the CC and the NACK packets may be used to produce measurements of the RTT as they rely on the same testRTT_sequence field for measuring the RTT in the present invention.

Referring to FIG. 4(b), the purpose of rate(t) field in NACK messages shown in FIG. 3 according to the embodiment of the present invention is to quickly overcome the loss of CC packets over the path from client 14 to server 12, without waiting for retransmission timeouts (RTOs) as in the prior art system. If the rate(t) is sent in a CC packet, which gets lost, the client 14 may send a NACK with the same rate(t) immediately following the lost CC message, instead of waiting for a whole RTT cycle. This condition occurs when there are lost packets and a NACK is warranted. In the prior art system, the client 14, would need to wait for a timeout, where the RTO is typically a conservative (i.e., much higher) estimate of the actual RTT. In the present invention, if CC is lost, the following NACK will provide the server with the rate (t) much earlier than if the client 14 waited for a whole RTT to resend the CC message. As a consequence, the present invention provides a much quicker recovery of lost CC packets and eliminates unnecessary retransmission timeout (RTO) waiting when recovering lost CC packets. It is noted that each time a new CC or NACK packet is sent, the testRTT sequence is incremented by 1.

Referring to the top chart of FIG. 4b, when CC message with (r(t), 3) is lost (where r(t) is the new rate, and 3 is the testRTT_sequence), the client 14 can only overcome the loss of the CC message RTO time units later, upon an expiration of a timeout. Note that there is a NACK message (100,4) in between the two CC messages. The NACK message is under-utilized in the prior art. Consequently, the server 12 receives rate r(t) at time T1. In the present art (bottom of the figure), the NACK carries rate r(t) in addition to the sequence number of the lost packet (i.e., 100) and the next testRTT sequence (i.e., 4). Hence, the server 12 gets the rate much quicker, at time T0 instead of T1. Note that without the present invention, if retransmitted packet (100,4) comes back to the client before the RTO expires, the client 14 can infer the loss of the CC packet and retransmit the CC packet before the timer expires, but still a whole RTT (instead of RTO) time units are being wasted.

With continued reference to FIG. 3, the function of the second field, CA (control action) sequence, in both the CC and NACK packet is to convey congestion control sequence numbers to the server 12 and to prevent the server 12 from reacting to congestion control messages sent by the client 14 more than once per RTT. That is, the CA sequence provides a mechanism for the system to wait for a predetermined time period (or minimum congestion control cycle) prior to adapting the new sender rate. In the present invention, the minimum congestion control cycle, which represents the number of measured RTTs prior to specifying the new sender rate, may occur past one RTT. Thus, a number of RTTs are measured prior to allowing the server 12 to adapt the new sender rate. In addition, the minimum congestion control cycle may be different for increase and decrease phases of congestion control. To achieve this, the client 14 increments CA sequence only when a new congestion control action needs to be sent to the server 12, thus the server 12 must ignore rate r(t) received in packets with a CA sequence that is less than or equal to the server's local value of CA sequence. In addition, this method prevents the server 12 from reacting to reordered congestion control messages (e.g., obsolete CC and NACK messages arriving out-of-sequence) will not trigger a rate change.

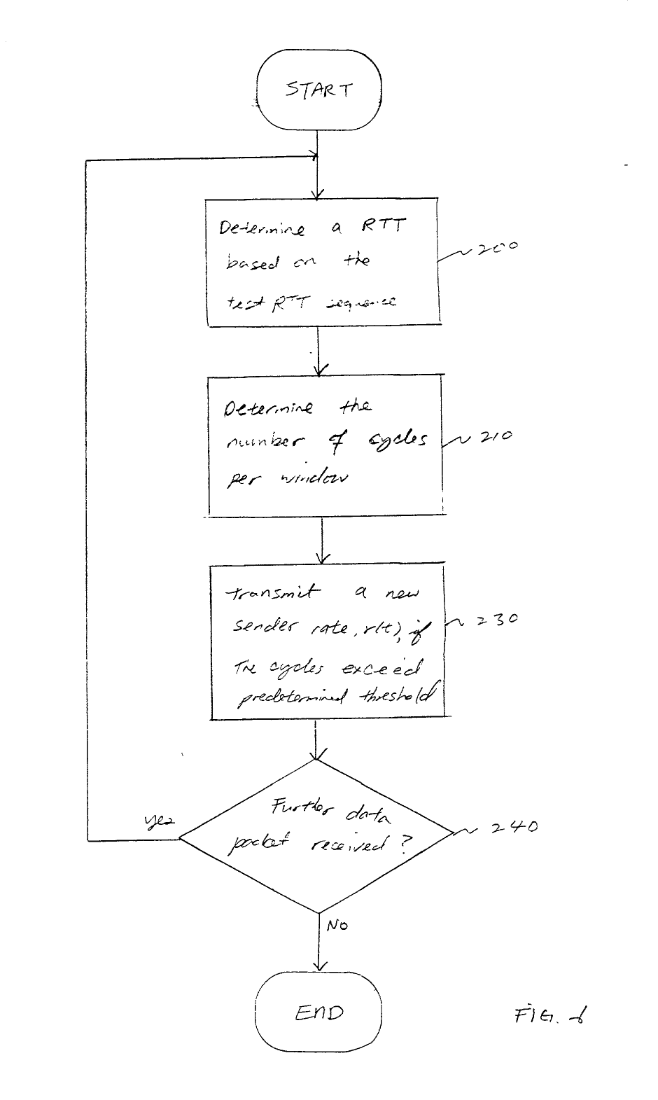

FIG. 5 illustrates the operation steps of how the client 14 decides on the frequency of congestion control actions (e.g., the duration of each cycle) and how the CA sequence is incremented according to the embodiment of the present invention. When the client 14 is communicatively connected to the server 12 and transmits control packets to the server 12, the client 14 communicates to the server 12 a rate value that indicates the rate at which the server 12 may transmit message packets thereto. Each subsequent message packet may include the congestion control information, which may alter the previously established rate value. Initially, the client 14 receives a packet from the server 12 with the testRTT sequence equal to i in step 100. In step 102, the client 14 determines whether the currently received testRTT sequence, i, is greater or equal to the previously executed testRTT sequence (last_action_seq). If so, the first round-trip time (RTT) is performed. In step 104, the cycle of the RTT measurement is incremented by 1. Then, in step 106, it is determined whether the current cycle of the RTT measurement exceeds a predetermined increase reference cycle (k_{I}*RTTs) or decrease cycle (k_{D}*RTTs). In a preferred embodiment, the value of k_{D} equals 1 and k_{I} is between 2 and 4. Hence, if the current cycles exceed either the k_{D} or k_{I} cycles, the client 14 will specify the server 12 to either increase or reduce the sending rate using either the CC or NACK packets. If the new cycle that is updated in step 104 is greater than the respective predetermined reference cycle in step 108 or in step 110, the CA_seq is increased by one and the sending rate is changed to a new rate, which is calculated based on the RTT, in step 112. As the value of the RTT constantly changes, the client 14 cannot rely on its previously measured values of the RTT and must rely on RTT measured at the timing of each CC and NACK request. That is, if a new CC action takes place at time t and the client's current value of CA sequence is j, the client 14 increments the value of CA sequence to j+1 at time t and sends either the CC or a NACK (when there are lost packets that need recovery) to the server 12. If the current cycles do not exceed either the k_{D} or k_{I} cycles in step 108 and 110, respectively, the client updates the value of testRTT in step 114. The CA sequence numbers are not changed during step 114, but only the testRTT sequence numbers are changed. In other words, if the client 14 changed the sending rate r(t) at time t, it must maintain the same rate for k_{I} round-trip delays before an increase is allowed, e.g., the next increased action will take place at time t+k_{I}*RTT Similarly, if the next action is a decrease, the minimum amount of time that r(t) needs to be maintained is k_{D} round-trip delays. As the last resort, the client 14 may start a retransmission timeout (RTO) timer for each send NACK and each CC packet to overcome the loss of control (i.e., NACK and CC) messages. For each CC or NACK-packet transmitted, the present invention maintains a timer. If the timer expires before the client gets a server packet with a testRTT_sequence greater than or equal to the last one sent, the corresponding CC or NACK-packet is retransmitted.

FIG. 6 illustrates the operation steps that enable the client 14 to overcome packet loss and adjust the sender rate of the server 12 without requiring a retransmission timeout (RTO) mechanism. Initially, the server 12 sends at least one source packet to the client 14 over the network. As shown in FIG. 4, if the source packet from the server 12 to the client 14 is transmitted in error or lost, the client 14 transmits a negative acknowledgment (NACK) packet to the server 12 for retransmission. If the retransmitted packet is lost, the client infers the loss from the testRTT_sequence field of subsequent source packets (see example in FIG. 4). In the embodiment, the client 14 in a real-time session must periodically measure the round-trip delay. The RTT is the duration between sending a NACK or a CC message and receiving the corresponding retransmission or the first server packet that acknowledges that the server received the corresponding request from the client. Note that in this invention, each CC message provides a measurement of the RTT. Since CC messages are quite frequent, the client obtains RTT samples with a high frequency, achieving the same performance as in ACK-based congestion control schemes. In step 210, the RTT is repeatedly measured by the client 14 by obtaining additional samples of the round-trip delay prior to setting the new sender rate. In step 230, if a number of predetermined cycles is reached, the client 14 transmits the most recently calculated RTT while incrementing the control action (CA) sequence by one to notify the server 12 to adjust the sender rate. Thereafter, if further data packets are received by the client 14, the operation steps 200-230 are repeated again.

In summary, the present invention provides a new framework for congestion control in NACK-based protocols, which achieves significant performance improvements (e.g., low rate oscillation, reselience against packet loss and reordering, detection of lost retransmissions with no timeouts, measurement of the RTT from each CC/NACK message, and NACK-based retransmission with very few duplicate packets over the existing NACK-based congestion control methods. Having thus described a preferred embodiment for managing congestion control messages over a digital communications link, it should be apparent to those skilled in the art that certain advantages of the system have been achieved. The foregoing is to be constructed as only being an illustrative embodiment of this invention. Thus, persons skilled in the art can easily conceive of alternative arrangements providing a functionality similar to this embodiment without any deviation from the fundamental principles or the scope of this invention.

What is claimed is:

1. A method for adjusting a sender rate in a packet communication system to support congestion control between a server and a client, the method comprising the steps of:
(a) transmitting a plurality of data packets to said client;
(b) determining by said client whether one of said data packets is lost over a communication connection from said server to said client;
(c) transmitting a response packet for retransmission by said client if one of said data packets is lost;
(d) computing a new sender rate based on a round-trip time (RTT) corresponding to a latency between sending said response packet to said server and receiving the corresponding retransmission of said lost packet from said server; and,
(e) transmitting said new sender rate to said server if a predetermined number of said RTTs is detected thereafter during said communication connection.

2. The method of claim 1, wherein said RTT is determined according to the following steps:
transmitting a first packet having an RTT sequence number to said server if one of said data packets is lost;
receiving a second packet containing said lost packet in response to said first packet from said server; and,
calculating said round-trip time (RTT) based on a time delay between said first packet and said second packet.

3. The method of claim 1, wherein said communication connection between said server and said client comprises at least one of a wireless communications link, a wired communication link, and the combination of a wired communication link and a wireless communications link.

4. The method of claim 1, further comprising the steps of:
including by said client a number of acknowledgment messages, in response to the plurality of said data packets, said new sender rate specifying a transmission rate at which said server may transmit subsequent data packets to said client; and,
adjusting by said server, in response to said acknowledgment messages, said new sender rate at which said server sends subsequent data packets to said client.

5. The method of claim 1, further comprising the steps of:
including a field in said response packet an RTT sequence number and said new sender rate; and,
determining by said client that one of said data packets is lost if said RTT sequence number received from said server is out of order.

6. The method of claim 1, further comprising the steps of:
including a field in said response packet a control action (CA) sequence number indicating the transmission of said new sender rate to said server; and,
adjusting, by said server, said new sender rate if said predetermined number of said RTTs is detected thereafter.

7. The method of claim 1, wherein said response packet is one of a negative acknowledgment (NACK) packet and a control action (CC) packet indicating the transmission of said new sender rate to said server.

8. The method of claim 1, wherein said computation of said new sender rate is based on a packet loss ratio.

9. A method for exchanging a plurality of messages between a server and a client over a communication link to support congestion control therebetween, the method comprising the steps of:
(a) transmitting a plurality of data packets from said server to said client;
(b) transmitting, by said client, a negative acknowledgment (NACK) packet for retransmission if one of said burst packets is lost;
(c) calculating, by said client, a round-trip time (RTTᵢ) corresponding to a latency between sending said NACK packet to said server and receiving the corresponding retransmission of said lost packet from said server;
(d) determining a new sender rate based on said calculated RTT indicating a transmission rate at which said server may transmit subsequent data packets to said client;
(e) successively transmitting a number of response packets responsive to the plurality of said data packets containing said new sender rate; and,
(f) adjusting, by said server, said new sender rate if said RTT is calculated more than a predetermined threshold value.

10. The method of claim 9, wherein said RTT is determined according to the following steps:
transmitting a first packet having an RTT sequence number to said server if one of said data packets is lost;
receiving a second packet containing said lost packet in response to said first packet from said server; and,
calculating said RTT based on a time delay between said first packet and said second packet.

11. The method of claim 9, wherein said communication link between said server and said client comprises at least one of a wireless communications link, a wired communication link, and the combination of a wired communication link and a wireless communications link.

12. The method of claim 9, further comprising the steps of:
including, by said client, a number of acknowledgment messages, in response to the plurality of said data packets, said new sender rate specifying a transmission rate at which said server may transmit subsequent data packets to said client; and,
adjusting by said server, in response to said acknowledgment messages, said new sender rate at which said server sends subsequent data packets to said client.

13. The method of claim 9, further comprising the steps of:
including a field in said response packet a RTT sequence number and said new sender rate; and,
determining by said client that one of said data packets is lost if said RTT sequence number received from said server is out of order.

14. The method of claim 9, further comprising the steps of:
including a field in said response packet a control action (CA) sequence number indicating the transmission of said new sender rate to said server; and,
adjusting, by said server, said new sender rate if said predetermined number of said RTTs is detected thereafter.

15. The method of claim 9, wherein said response packet is one of a negative acknowledgment (NACK) packet and a control action (CC) packet indicating the transmission of said new sender rate to said server.

16. A system for adjusting a sender rate in a packet communication system to support congestion control between a server and a client, comprising:
means for receiving a plurality of data packets;
means for determining whether one of said data packets is lost during transmission;
means for requesting that any lost frame packets be retransmitted;
means for computing a new sender rate based on a round-trip time (RTT) corresponding to a latency between requesting retransmission of said lost frame to said server and receiving corresponding retransmission of said lost frame from said server; and,
means for notifying said new sender rate to said server if said RTT is calculated more than a predetermined threshold value.

17. The system of claim 16, wherein said RTT is determined according to the following steps:
transmitting a first packet having an RTT sequence number to said server if one of said data packets is lost;
receiving a second packet containing said lost packet in response to said first packet from said server; and,
calculating said round-trip time (RTT) based on a time delay between said first packet and said second packet.

18. The system of claim 16, wherein said first packet includes said new sender rate specifying a transmission rate at which said server may transmit subsequent data packets to said client and an RTT sequence number, and wherein one of said data packets is determined to be lost if said RTT sequence number received from said server is out of order.

19. The method of claim 16, wherein said first packet includes a control action (CA) sequence number indicating the transmission of said new sender rate to said server.

20. The method of claim 16, further comprising means for adjusting said new sender rate at which said server sends subsequent data packets to said client.

21. A system for exchanging a plurality of messages between a server and a client over a communication link to support congestion control therebetween, comprising:
means for transmitting a plurality of data packets from said server to said client;
means for transmitting, by said client, a negative acknowledgment (NACK) packet for retransmission if one of said burst packets is lost;
means for calculating, by said client, a round-trip time (RTTᵢ) corresponding to a latency between sending said NACK packet to said server and receiving the corresponding retransmission of said lost packet from said server;
means for determining a new sender rate based on said calculated RTT indicating a transmission rate at which said server may transmit subsequent data packets to said client;
means for successively transmitting a number of response packets responsive to the plurality of said data packets containing said new sender rate; and,
means for adjusting, by said server, said new sender rate if said RTT is calculated more than a predetermined threshold value.

22. The system of claim 21, wherein said RTT is determined according to the following steps:
transmitting a first packet having an RTT sequence number to said server if one of said data packets is lost;
receiving a second packet containing said lost packet in response to said first packet from said server; and,
calculating said round-trip time (RTT) based on a time delay between said first packet and said second packet.

23. The system of claim 21, wherein said first packet includes said new sender rate specifying a transmission rate at which said server may transmit subsequent data packets to said client and an RTT sequence number, and wherein one of said data packets is determined to be lost if said RTT sequence number received from said server is out of order.

24. The system of claim 21, wherein said first packet includes a control action (CA) sequence number indicating the transmission of said new sender rate to said server.
